(19) United States
(12) Patent Application Publication
(10) Pub. No.: US 2018/0307733 A1
(43) Pub. Date: Oct. 25, 2018

(54) USER CHARACTERISTIC EXTRACTION METHOD AND APPARATUS, AND STORAGE MEDIUM

(71) Applicant: Tencent Technology (Shenzhen) Company Limited, Shenzhen (CN)

(72) Inventors: Yuan Sun Zou, Shenzhen (CN); Huang Tang, Shenzhen (CN); Jia Xin Lin, Shenzhen (CN); Jun Li, Shenzhen (CN); Ye Shou Cai, Shenzhen (CN)

(73) Assignee: Tencent Technology (Shenzhen) Company Limited, Shenzhen (CN)

(21) Appl. No.: 16/018,919

(22) Filed: Jun. 26, 2018

Related U.S. Application Data
(63) Continuation of application No. PCT/CN2017/102690, filed on Sep. 21, 2017.

(30) Foreign Application Priority Data
Sep. 22, 2016 (CN) 201610843241.1

(51) Int. Cl. G06F 17/30; G06Q 30/02

(52) U.S. Cl. CPC G06F 17/30539; G06Q 30/0277; G06F 17/30589

(57) ABSTRACT

A user characteristic extraction method, apparatus, and a storage medium storing instructions for implementing the user characteristic extraction method are provided. According to the user characteristic extraction method, because operation object characteristics are divided into different levels, a data granularity of the operation object characteristic is finer as a level number decreases in the operation object characteristics of different levels. Accordingly, a user characteristic of a fine granularity can be mined from a level of the operation object characteristic that is of a fine granularity, thereby meeting requirements of some use scenarios that need to use a user characteristic of a fine granularity.

### CROSS-REFERENCE TO RELATED APPLICATION(S)

This application is a continuation of International Patent Application No. PCT/CN2017/102690, filed on Sep. 21, 2017, which claims priority to Chinese Patent Application No. 201610843241.1, filed with the Chinese Patent Office on Sep. 22, 2016, and entitled “USER CHARACTERISTIC EXTRACTION METHOD AND RELATED APPARATUS”, the entirety of all of which are hereby incorporated by reference herein.

### FIELD OF THE TECHNOLOGY

This application relates to the field of data processing technologies, and specifically, to a user characteristic extraction method and apparatus, and a storage medium.

### BACKGROUND OF THE DISCLOSURE

User characteristics are mainly used for describing characteristic attributes of a user, for example, gender, age, occupation, hobby, region, the regularity that the user visits websites, and other features. Mining of the user characteristics is to collect statistics about and analyze related data when basic data of website access traffic is obtained, to discover the characteristic attributes of the user. The mining of the user characteristics is of great significance to network marketing strategies. For example, a user preference is discovered by mining the user characteristics, to generate a personalized recommendation service corresponding to the user preference, so as to recommend the recommendation service that meets user demands to the user.

However, in the existing technology, user characteristics of a service scenario level are mainly mined, and user characteristics of a finer granularity cannot be mined. Therefore, the solution to mining user characteristics in the existing technology may result in that mined user characteristics are not accurate enough.

### SUMMARY

Embodiments of this application provide a user characteristic extraction method and related apparatus, which can mine user characteristics of a fine granularity, thereby improving accuracy of mined user characteristics.

The embodiments of this application provide the following technical solutions:

A user characteristic extraction method may include obtaining an activity log of a user, where the activity log includes a recording of an operation behavior generated during a network operation process of the user. The method may further include hierarchically extracting an operation object characteristic corresponding to the operation behavior from the operation behavior, to obtain operation object characteristics of different levels, where the operation object characteristics of different levels have finer data granularities in descending order of levels. The method may further include generating, for operation object characteristics of a same level, a user characteristic according to the operation behavior corresponding to the operation object characteristics.

A user characteristic extraction apparatus may include a processor, and a memory storing processor executable instructions that, when executed by the processor, causes the processor to obtain an activity log of a user, where the activity log recording an operation behavior generated during a network operation process of the user. The processor may further hierarchically extract an operation object characteristic corresponding to the operation behavior from the operation behavior, to obtain operation object characteristics of different levels, where the operation object characteristics of different levels have finer data granularities in descending order of levels. The processor may further generate, for operation object characteristics of a same level, a user characteristic according to the operation behavior corresponding to the operation object characteristics.

A non-volatile storage medium may be configured to store computer-readable instructions. The instructions, when executed, cause a processor to perform a user characteristic extraction method described herein.

Based on the foregoing technical solutions, the embodiments of this application disclose a user characteristic extraction method and apparatus, and a storage medium. The method includes: obtaining an activity log of a user, the activity log recording an operation behavior generated during a network operation process of the user; hierarchically extracting an operation object characteristic corresponding to the operation behavior from the operation behavior, to obtain operation object characteristics of different levels, the operation object characteristics of different levels having finer data granularities in descending order of levels; and generating, for operation object characteristics of a same level, a user characteristic according to the operation behavior corresponding to the operation object characteristics. It can be learned that according to the embodiments of this application, because the operation object characteristics are divided into different levels, a data granularity of the operation object characteristic is finer as a level number decreases (i.e., lower levels) in the operation object characteristics of different levels. According to the embodiments of this application, a user characteristic of a fine granularity can be mined from a level of the operation object characteristic that is of a fine granularity, thereby improving the accuracy of a mined user characteristic.

### BRIEF DESCRIPTION OF THE DRAWINGS

To describe the technical solutions in the embodiments of this application or in the existing technology more clearly, the following briefly introduces the accompanying drawings required for describing the embodiments or the existing technology. Apparently, the accompanying drawings in the following description show merely the embodiments of this application, and a person of ordinary skill in the art may still derive other drawings from these accompanying drawings without creative efforts.

FIG. 1 shows a flowchart of a user characteristic extraction method according to an embodiment of this application;

FIG. 2 shows a flowchart of a method for marking each operation object characteristic of different levels, to obtain a score corresponding to each operation object characteristic of different levels according to an embodiment of this application;

FIG. 3 shows a flowchart of another method for marking each operation object characteristic of different levels, to obtain a score corresponding to each operation object characteristic of different levels according to an embodiment of this application;

FIG. 4 shows a flowchart of still another method for marking each operation object characteristic of different levels, to obtain a score corresponding to each operation object characteristic of different levels according to an embodiment of this application;

FIG. 5 shows a structural block diagram of a user characteristic extraction apparatus according to an embodiment of this application;

FIG. 6 shows a hardware structural block diagram of a user characteristic extraction apparatus according to an embodiment of this application; and

FIG. 7 shows a schematic structural diagram of an advertisement push system according to an embodiment of this application.

### DESCRIPTION OF EMBODIMENTS

The following disclosure describes the technical solutions in the embodiments of this application with reference to the accompanying drawings in the embodiments of this application. The described embodiments are provided for exemplary purposes, as other embodiments may be implemented that remain within the scope of the features described herein. Other embodiments obtained by a person of ordinary skill in the art based on the embodiments of this application without creative efforts shall fall within the protection scope of this application.

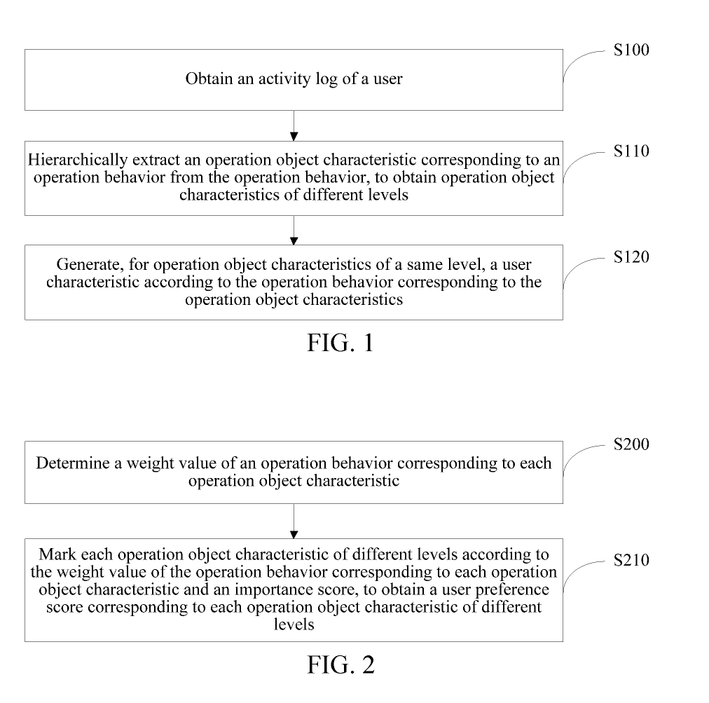

FIG. 1 shows a flowchart of a user characteristic extraction method according to an embodiment of this application. The method is performed by a processor and includes the following steps.

Step S100: Obtain an activity log of a user.

The activity log may record an operation behavior generated during a network operation process of the user, including an operation behavior generated during a process of visiting any website by the user. The activity log of the user may be a data table, a file on a distributed system infrastructure, or streaming data, or other data structure that is not limited in this embodiment of this application. For example, that the user opens an entertainment program in a video website and watches the program for an hour, or that the user visits a piece of sports news in a news website, or that the user opens a shopping website and browses some shops all belongs to the operation behavior that is recorded in the activity log and generated during the network operation process of the user.

Step S110: Hierarchically extract an operation object characteristic corresponding to the operation behavior from the operation behavior, to obtain operation object characteristics of different levels.

A data granularity of the operation object characteristic is finer as a level number decreases in the operation object characteristics of different levels.

The operation object characteristic is a characteristic of an operation object corresponding to the operation behavior of the user. For example, the operation behavior of the user is listening to a song, the music is the operation object, and the operation object characteristic is a song name, a song singer, a song issue time, a song type, or the like.

According to this embodiment of this application, the data granularity of the operation object characteristic is finer as the level number decreases in the operation object characteristics of different levels. A data granularity of an operation object characteristic of the lowest level is the finest, and a data granularity of an operation object characteristic of the highest level is the coarsest. Therefore, data objects at a higher level may cover a plurality of data objects at a lower level.

For example. a first level is a keyword level, and operation object characteristics in the keyword level are mainly words extracted from the operation behavior, for example, universe, black hole, upper outer garment, and pants; a second level is a text topic level, and operation object characteristics in the text topic level are text topics extracted from the operation behavior, for example, science and clothes; and a third level is a scenario type level, and operation object characteristics in the scenario type level are mainly scenario types extracted from the operation behavior, for example, a news type and a shopping type. A granularity of the operation object characteristic included in the keyword level of the first level is the finest, and a data granularity of the operation object characteristic included in the scenario type level of the third level is the coarsest.

Optionally, this embodiment of this application is not limited to the operation object characteristics of the three levels disclosed above. According to this embodiment of this application, the operation object characteristic corresponding to the operation behavior may be hierarchically extracted from the operation behavior of the user on the network according to a preset hierarchical class direction and hierarchical granularity level, to obtain the operation object characteristics of different levels.

The hierarchical class direction of the operation object characteristics may be defined by a person skilled in the art. The hierarchical class direction of the operation object characteristics is a class direction for dividing the operation object characteristics into levels. For example, a program in a video website browsed by the user may be divided into levels according to a program subject or divided into levels according to a program type. For example, three levels of operation object characteristics obtained by browsing the video website by the user are respectively a Titanic, a romance type, and a video. Alternatively, three levels of operation object characteristics obtained by browsing the video website by the user may be respectively a Titanic, a movie, and a video.

The hierarchical granularity level may also be defined by a person skilled in the art and may be defined as three levels, four levels, or five levels. This is not specifically limited in this embodiment of this application.

It should be noted that according to this embodiment of this application, the operation object characteristic corresponding to the operation behavior is hierarchically extracted to obtain the operation object characteristics of different levels. An extraction process of operation object characteristics of each level uses different extraction methods, and an extraction process of operation object characteristics of a same level may also use different extraction methods, so that the operation object characteristics corresponding to the operation behavior can be quickly and accurately extracted from a large quantity of activity logs of the user.

Optionally, for the keyword level, the following extraction methods may be used in this embodiment of this application to extract operation object characteristics in the keyword level: a Chinese word segmentation method, a compound word mining method, a keyword extraction method, or the like.

For the text topic level, the following extraction methods may be used in this embodiment of this application to extract operation object characteristics in the text topic level: a word embedding method, a subject extraction method, a text classification method or clustering method, or the like.

For the scenario class level, the following extraction methods may be used in this embodiment of this application to extract operation object characteristics in the scenario class level: constructing and designing according to a mapping relationship with the text topic level.

It should be noted that this embodiment of this application is not limited to the extraction methods for the operation object characteristics disclosed above.

Step S120: Generate, for operation object characteristics of a same level, a user characteristic according to the operation behavior corresponding to the operation object characteristics.

It should be noted that this embodiment of this application mainly maps the operation object characteristics and the operation behavior corresponding to the operation object characteristics to the user, to obtain the user characteristics. For example, the three levels of operation object characteristics obtained by browsing the video website by the user are respectively a Titanic, a romance type, and a video. Therefore, the user characteristics obtained by mapping may be that the user likes watching a video, and likes watching a romance type video.

Optionally, according to this embodiment of this application, the user characteristics may be generated for the operation object characteristics of different levels according to actual needs. When a user characteristic of a fine granularity needs to be obtained, the user characteristic may be generated according to operation object characteristics of a lower level; and when a user characteristic of a coarse granularity needs to be obtained, the user characteristic may be generated according to operation object characteristics of a higher level. This is not specifically limited in this embodiment of this application.

According to the technical solutions of this embodiment of this application, the activity log of the user may be obtained in real time, the operation object characteristic corresponding to the operation behavior may be hierarchically extracted from the operation behavior, and the user characteristic may be generated in real time, so as to recommend, according to the user characteristic generated in real time, a product or service in which the user is interested to the user in time.

It should be noted that the user characteristic extraction method disclosed in this embodiment of this application introduces a workflow mode to organically synthesize data, an algorithm, and computation, and achieves better data scalability, algorithm commonality, and application scalability. This solution modularizes each specific process flow in the user characteristic extraction method, and each module coordinates with each other by using a defined mining task. Each module only needs to focus on a data flow of the processing of the module, thereby coupling between the modules are reduced. User characteristic mining in different scenarios may use the user characteristic extraction method disclosed in this embodiment of this application.

Therefore, this embodiment of this application provides a universal user characteristic extraction method which has fine data scalability at a data level. Therefore, problems that different data sources need to be separately designed and a mining solution needs to be maintained are resolved, and different data source information may be integrally utilized, to mine the user characteristics more accurately. In terms of designing and mining the user characteristics, with reference to specific service practice experience, descriptions of the user characteristics of different levels are designed, so that one mining solution can meet requirements of different service scenarios.

A practical application scenario of the user characteristic extraction method disclosed in this embodiment of this application may be a user persona or advertisement targeting.

The user persona is mainly used for describing user attributes, and currently mainly focuses on the following aspects: demography, a user identity status, and a scenario interest. Demography characteristics mainly include gender, age, region and the like; the identity status may be personal information of the user such as educational background, occupation, and income; and interest-type personas may be specifically defined according to a scenario behavior of the user. For example, when the user is watching a video, watching interests of the user may be defined. Such interests may be based on a type of the video watched by the user. Preferences of the user on different subjects may be mined by using the user characteristic extraction method disclosed in this embodiment of this application. The subjects of the video may be comedy, swordsmen, romance, urban, fantasy and the like.

A case of a specific use scenario of the user persona is a product recommendation service. For example, in a video service, there are tens of millions of active watching users each day and millions of video resources. A personalized recommendation service is provided for the user by using methods such as collaborative filtering and matrix factorization based on popularity. Based on a watching behavior of the user, a user interest characteristic is mined by using the user characteristic extraction method disclosed in this embodiment of this application. Based on the user interest characteristic, a collaborative filtering algorithm, a matrix factorization algorithm, or a logistic regression algorithm may be used to predict a preference degree of the user for films and dramas, and then films and dramas are recommended to the user.

The advertisement targeting is that when pushing an advertisement in Moments, an advertiser may synthesize features and user targets of a product of the advertiser, to select audience groups to which the product is exposed. For example, a corporation needs to push an advertisement of a new electric vehicle priced at 600,000 RMB. Users to which the corporation expects to expose the advertisement are users whose age is 24 to 45, yearly salary is 400,000 RMB and more, and region is a first-tier city, and who have driving experience, are willing to accept innovations, are adventurous, and like science and technology products. User characteristics that are mined by using the user characteristic extraction method disclosed in this embodiment of this application and that conform to the foregoing conditions are: 23 to 45-year-old, high net value, wealth management, gold collar worker, Bei-Shang-Guang-Shen, vehicle, science and technology, sports, outdoor, electronics product. Based on the foregoing mined user characteristics, users that satisfy the foregoing user characteristics may be found as target users of the advertisement push.

It should be noted that after the hierarchically extracting an operation object characteristic corresponding to the operation behavior from the operation behavior, to obtain operation object characteristics of different levels, this embodiment of this application further includes: marking each operation object characteristic of different levels, to obtain a score corresponding to each operation object characteristic of different levels.

The process of marking each operation object characteristic of different levels, to obtain a score corresponding to each operation object characteristic of different levels includes: determining a quantity of occurrences of each operation object characteristic of different levels in the activity log of the user; determining an importance indicator of each operation object characteristic of different levels in the activity log of the user; and marking each operation object characteristic of different levels according to the quantity of occurrences of each operation object characteristic of different levels in the activity log of the user and the importance indicator in the activity log of the user, to obtain an importance score corresponding to each operation object characteristic of different levels.

The following describes two specific algorithms for marking each operation object characteristic of different levels, to obtain the importance indicator corresponding to each operation object characteristic of different levels:

Algorithm 1:

score(source,item,tag)=tf*idf

score(source, item, tag) is a score corresponding to an operation object characteristic, source is an activity log source of the operation object characteristic, item is a level to which the operation object characteristic belongs, and tag is the operation object characteristic; and

tf is a quantity of occurrences of the operation object characteristic in all operation objects of a same level, and idf is an importance indicator of the operation object characteristic.

Specifically,

$$idf = log \frac{‖ D ‖}{( ‖ {D}_{i} ‖ + 1 )} ,$$

where ∥D∥ is a quantity of the operation objects in the same level, and ∥Dₜ∥ is a quantity of operation objects having the operation object characteristic in the same level.

Each operation object characteristic of different levels is marked according to the foregoing algorithm, to obtain the importance indicator corresponding to each operation object characteristic of different levels.

Algorithm 2:

All operation object characteristics in a same level are portioned into several composition units by using a TextRank model and a graph model is established. Importance of any operation object characteristic is sorted by using a voting mechanism. The TextRank model may mathematically represents a weighted and directed graph G=(V, E), where V is a set of all the operation object characteristics in the same level, and E is a set of relations of all the operation object characteristics in the same level. Assuming that a relation weight of an edge between any two points Vi and Vj (that is, any two operation object characteristics) is wji, for a given point Vi (that is, a given operation object characteristic), In(Vi) is a set of points that point to this point, and Out(Vi) is a set of points to which the point Vi points, and a score of the point Vi is defined as follows:

$$score ( item , {v}_{i} ) = ( 1 - d ) + d * {\sum }_{{v}_{j} ∈ In ( {v}_{i} )} \frac{{w}_{ji}}{{\sum }_{{v}_{k}} out ( {v}_{j} )} * score ( item , {v}_{j} )$$

score(item, vᵢ) is a score of the operation object characteristic vᵢ in the item level, and score(item, vⱼ) is a score of the operation object characteristic vⱼ in the item level, where d is a constant less than 1.

A score of each point is iteratively computed by using the foregoing formula until convergence, to obtain a final score of an operation object characteristic; and

each operation object characteristic of different levels is marked according to the foregoing algorithm, to obtain the importance indicator corresponding to each operation object characteristic of different levels.

Optionally, FIG. 2 is a flowchart of a method for marking each operation object characteristic of different levels, to obtain a score corresponding to each operation object characteristic of different levels according to an embodiment of this application. Referring to FIG. 2, the method may include the following steps:

Step S200: Determine a weight value of the operation behavior corresponding to each operation object characteristic.

Step S210: Mark each operation object characteristic of different levels according to the weight value of the operation behavior corresponding to each operation object characteristic and the importance score corresponding to each operation object characteristic, to obtain a user preference score corresponding to each operation object characteristic of different levels.

Specifically, score(user,source,tag)=action_weight*score(source, item, tag).

score(user, source, tag) is the score corresponding to the operation object characteristic, score(source, item, tag) is the importance score corresponding to the operation object characteristic, source is the activity log source of the operation object characteristic, item is a level to which the operation object characteristic belongs, tag is the operation object characteristic, and user is a user name to which the operation object characteristic belongs.

action_weight is a weight value of the operation behavior corresponding to the operation object characteristic. The weight value indicates a preference degree of the user for the operation object characteristic. The weight value may be defined by a person skilled in the art according to a situation in an actual scenario. For example, in a scenario in which the user visits a video website, because that the user watches a video indicates that the user prefers the video, and that the user clicks the video but does not watch the video indicates that a preference degree of the user for the video is lower, a weight value of an operation behavior of watching the video by the user is greater than a weight value of an operation behavior of clicking the video by the user. In a scenario in which the user visits a shopping website, a weight value of an operation behavior of purchasing a commodity by the user is greater a weight value of an operation behavior of adding the commodity into a shopping cart by the user, and the like. This embodiment of this application is not limited to the foregoing situations.

In this embodiment of this application, according to the technical solution, each operation object characteristic of different levels is marked according to the weight value of the operation behavior corresponding to each operation object characteristic and the importance score corresponding to each operation object characteristic, to obtain the user preference score corresponding to each operation object characteristic of different levels. Thereby, an impact of an operation behavior corresponding to an important operation object characteristic on the user characteristics is considered, to obtain more accurate user characteristics.

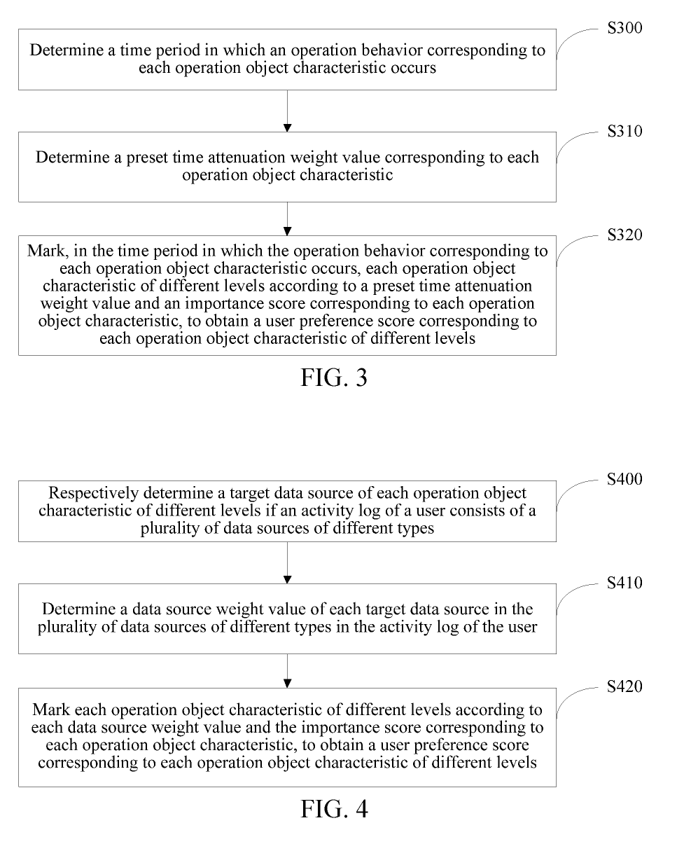

Specifically, FIG. 3 is a flowchart of another method for marking each operation object characteristic of different levels, to obtain a score corresponding to each operation object characteristic of different levels according to an embodiment of this application. Referring to FIG. 3, the method may include the following steps:

Step S300: Determine a time period in which the operation behavior corresponding to each operation object characteristic occurs.

Step S310: Determine a preset time attenuation weight value corresponding to each operation object characteristic.

It should be noted that this embodiment of this application may use an exponential time attenuation method, or use a linear time attenuation method. This is not specifically limited in this embodiment of this application.

A specific time attenuation weight value may be determined by a person skilled in the art according to an operation behavior in an actual scenario. For example, for a news type, an updating time is shorter, therefore, time attenuation is faster, and a defined time attenuation weight value is larger; and for TV series watched by the user, an updating time is long, therefore, time attenuation is slower, and a defined time attenuation weight value is smaller.

Step S320: Mark, in the time period in which the operation behavior corresponding to each operation object characteristic occurs, each operation object characteristic of different levels according to the preset time attenuation weight value corresponding to each operation object characteristic and the importance score corresponding to each operation object characteristic, to obtain a user preference score corresponding to each operation object characteristic of different levels.

Time attenuation is performed on the importance score score(user, source, tag) corresponding to the operation object characteristic obtained in the foregoing embodiment, to obtain the user preference score corresponding to the operation object characteristic on which the time attenuation is performed:

$${\sum }_{d = 1}^{T} score ( user , source , tag ) \cdot {e}^{\frac{- d}{ϕ}} .$$

$${e}^{\frac{- d}{ϕ}}$$

is a time attenuation weight value, φ is a given attenuation basis, d is days of attenuation. If φ=30 is given, when d=30, the time attenuation weight value is e⁻¹. T is time period in which the operation behavior corresponding to the operation object characteristic occurs.

According to this embodiment of this application, in the time period in which the operation behavior corresponding to each operation object characteristic occurs, each operation object characteristic of different levels is marked according to the preset time attenuation weight value corresponding to each operation object characteristic and the importance score corresponding to each operation object characteristic, to obtain the user preference score corresponding to each operation object characteristic of different levels. Thereby, an impact of a time factor on the operation object characteristics is considered to enable the obtained user characteristics to satisfy a current user situation more, so as to obtain more accurate user characteristics.

Specifically, FIG. 4 is a flowchart of still another method for marking each operation object characteristic of different levels, to obtain a score corresponding to each operation object characteristic of different levels according to an embodiment of this application. Referring to FIG. 4, the method may include the following steps:

Step S400: Respectively determine a target data source of each operation object characteristic of different levels if the activity log of the user consists of a plurality of data sources of different types.

This embodiment of this application may use an account universal in different scenarios to load the data sources of different types. For example, a user name logged into by the user in different scenarios may be a same mobile number or a same e-mail account.

Step S410: Determine a data source weight value of each target data source in the plurality of data sources of different types in the activity log of the user.

Step S420: Mark each operation object characteristic of different levels according to each data source weight value and the importance score corresponding to each operation object characteristic, to obtain a user preference score corresponding to each operation object characteristic of different levels.

A marking solution that integrates a plurality of data sources and that is used by the user in a period to mark the user preference score corresponding to a single operation object characteristic is as follows:

$${\sum }_{i ∈ set ( source )} {\sum }_{d = 1}^{T} score ( user , {source}_{i} , tag ) \cdot {e}^{\frac{- d}{ϕ}} \cdot {source\_weight}_{i} .$$

set(source) represents a set of data sources of different types in the activity of the user, source_weight represents a weight of each data source in the activity log of the user, T is a time period in which the operation behavior corresponding to the operation object characteristic occurs, and

$$score ( user , {source}_{i} , tag ) \cdot {e}^{\frac{- d}{ϕ}}$$

is a user preference score corresponding to an operation object characteristic on which time attenuation is performed and that corresponds to a data source in the activity log of the user.

According to this embodiment of this application, in the user characteristic extraction process, the case in which the activity log of the user consists of a plurality of data sources of different types is considered. For different scenarios, the user may have different preferences for data sources of different types. For example, for users to which a movie trailer advertisement is pushed, the users focus on data sources of a video type and a news type; and for users to which a game advertisement is pushed, the users focus on data sources of user groups of mobile software. If an advertisement is pushed in a WeChat official account, a data source related to data from the official account is given a weight higher than other data sources; and if an advertisement is a movie advertising video, a data source of a video entertainment type is given a higher weight. Therefore, in this embodiment of this application, the user preference score corresponding to the operation object characteristic is obtained with reference to the weight of each data source in the activity log of the user, to obtain more accurate user characteristics with reference to the user preference score corresponding to the operation object characteristic.

In addition, for a new video user, because the user does not have any behavior data of watching in the video scenario, a user characteristic cannot be obtained only based on the video data source, that is, a preference of the user on the video cannot be mined. A data source in another scenario is loaded, for example, a data source of user news, article reading interest or other aspects, to extract some user characteristics. That is, interest features of the user in another scenario are used for describing the user, to effectively alleviate a clod start problem of the user that is common in information recommendation.

Based on the foregoing embodiment, in the process of generating, for operation object characteristics of a same level, a user characteristic according to the operation behavior corresponding to the operation object characteristics according to this application, the user characteristic may be generated based on the operation object characteristics, the scores corresponding to the operation object characteristics, and the operation behavior corresponding to the operation object characteristics.

The following uses a specific example to describe in detail the user characteristic extraction method disclosed in the foregoing embodiments of this application:

1. Obtain an activity log of a user. The obtaining an activity log of a user is to collect the activity log by using a data collection system, to localize the activity log as a data table in a data warehouse, and to store the activity log in a distributed file system in a form of a file.

2. Compile a file. The file is mainly used for describing data sources used in a user characteristic extraction process to mine a granularity level of a user characteristic, data integration method, weight allocation of different data sources, and time attenuation method for the user characteristic, and the like. The following is a specific example of the file:
#MiningJobConfig
[data_source]
source=video, news
[video]
source=video
data_hdfs_path=video_hdfs_path
data_schema_path=video_schema_path
actionType=watch: watchWeight, click: clickWeight
item_text_field=video_text_fielname
action_duration=30 d
decay_mode=exp_model
encoding=utf-8
[news]
source=news
data_hdfs_path=news_hdfs_path
data_schema_path=news_schema_path
actionType=read: readWeight, click: clickWeight
item_text_field=news_text_fielname
action_duration=30 d
decay_mode=exp_model
encoding=utf-8
[feature]
feature_level=keyword, topic, category
feature_algorithm=keyword: textrank, topic: word2vec_kmeans
[source_merge]
weight_assign=video: video_weight, news: news_weight
[mined_result]
feature_path=feature_hdfs_path

In the foregoing file, data_source defines a data source including video and news required to be used in the user characteristic extraction process;

in video data, a storage path of operation behavior data of the user is defined as: data_hdfs_path=video_hdfs_path;

an organization method of data is: data schema_path=video_schema_path;

weight allocation of video watching and clicking behaviors in user characteristic computation is: actionType=watch: watchWeight, click: clickWeight;

a text field name in the video is: item_text_field=news_text_fielname;

a time period of the user characteristic extraction is: action_duration=30 d, and herein is 30 days;

a form of time attenuation is decay_mode=eps_model, representing daily attenuation in an exponential form; and

a code method of the file is encoding=utf-8; and

in news data, a storage path of operation behavior data of the user is defined as: data_hdfs_path=news_hdfs_path;

an organization method of data is: data_schema_path=news_schema_path;

weight allocation of news reading and clicking behaviors in user characteristic computation is:

actionType=read: readWeight, click: clickWeight;

a text field name in the news is: item_text_field=news_text_fielname;

a time period of the user characteristic extraction is: action_duration=30 d, and herein is 30 days;

a form of time attenuation is decay_mode=eps_model, representing daily attenuation in an exponential form;

a code method of the file is encoding=utf-8; and

[feature] defines that the user characteristic is extracted in a keyword level and a text topic level this time.

Methods respectively selected to extract the operation object characteristic in the keyword level and the text topic level are: The keyword level is mined based on textrank; the text topic level is mined based on word2vec and kmean, source_merge defines the integration method and weight allocation; and mined_result defines the storage path of the user characteristic.

3. Extract the user characteristic according to the extraction algorithm defined in the file after the file is defined.

The user characteristic extraction method disclosed in the embodiments of this application includes: obtaining an activity log of a user, the activity log recording an operation behavior generated during a network operation process of the user; hierarchically extracting an operation object characteristic corresponding to the operation behavior from the operation behavior, to obtain operation object characteristics of different levels, the operation object characteristics of different levels having finer data granularities in descending order of levels; and generating, for operation object characteristics of a same level, a user characteristic according to the operation behavior corresponding to the operation object characteristics. It can be learned that according to the embodiments of this application, because the operation object characteristics are divided into different levels, a data granularity of the operation object characteristic is finer as a level number decreases in the operation object characteristics of different levels. According to the embodiments of this application, a user characteristic of a fine granularity can be mined from a level of the operation object characteristic that is of a fine granularity, thereby meeting requirements of some use scenarios that need to use a user characteristic of a fine granularity.

The following describes a user characteristic extraction apparatus provided in the embodiments of this application. References may be made to the user characteristic extraction apparatus below and the user characteristic extraction method above correspondingly.

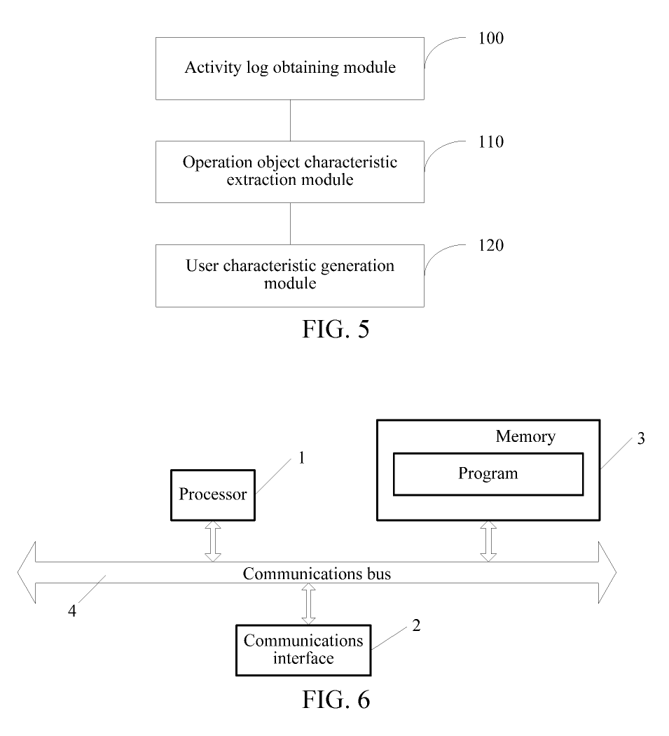

FIG. 5 is a structural block diagram of a user characteristic extraction apparatus according to an embodiment of this application. Referring to FIG. 5, the user characteristic extraction apparatus may include an activity log obtaining module 100, configured to obtain an activity log of a user, the activity log recording an operation behavior generated during a network operation process of the user. The user characteristic extraction apparatus may further include an operation object characteristic extraction module 110, configured to hierarchically extract an operation object characteristic corresponding to the operation behavior from the operation behavior, to obtain operation object characteristics of different levels, the operation object characteristics of different levels having finer data granularities in descending order of levels. The user characteristic extraction apparatus may further include a user characteristic generation module 120, configured to generate, for operation object characteristics of a same level, a user characteristic according to the operation behavior corresponding to the operation object characteristics.

An optional structure of the operation object characteristic extraction module includes an operation object characteristic extraction sub-module, configured to hierarchically extract the operation object characteristic corresponding to the operation behavior from the operation behavior of the user on a network according to a preset hierarchical class direction and hierarchical granularity level, to obtain the operation object characteristics of different hierarchies. The optional structure may further include an operation object characteristic mark module, configured to mark each operation object characteristic of different levels, to obtain a score corresponding to each operation object characteristic of different levels.

An optional structure of the operation object characteristic mark module includes a quantity determining module, configured to determine a quantity of occurrences of each operation object characteristic of different levels in the activity log of the user. The optional structure may further include an importance indicator determining module, configured to determine an importance indicator of each operation object characteristic of different levels in the activity log of the user. The optional structure may further include a first operation object characteristic mark sub-module, configured to mark each operation object characteristic of different levels according to the quantity of occurrences of each operation object characteristic of different levels in the activity log of the user and the importance indicator in the activity log of the user, to obtain an importance score corresponding to each operation object characteristic of different levels.

An optional structure of the operation object characteristic mark module includes an operation behavior weight value determining module, configured to determine a weight value of the operation behavior corresponding to each operation object characteristic. The optional structure may further include a second operation object characteristic mark sub-module, configured to mark each operation object characteristic of different levels according to the weight value of the operation behavior corresponding to each operation object characteristic and the importance score corresponding to each operation object characteristic, to obtain a user preference score corresponding to each operation object characteristic of different levels.

An optional structure of the operation object characteristic mark module includes a time period determining module, configured to determine a time period in which the operation behavior corresponding to each operation object characteristic occurs. The optional structure may further include a time attenuation weight value determining module, configured to determine a preset time attenuation weight value corresponding to each operation object characteristic. The optional structure may further include a third operation object characteristic mark sub-module, configured to mark, in the time period in which the operation behavior corresponding to each operation object characteristic occurs, each operation object characteristic of different levels according to the preset time attenuation weight value corresponding to each operation object characteristic and the importance score corresponding to each operation object characteristic, to obtain a user preference score corresponding to each operation object characteristic of different levels.

An optional structure of the operation object characteristic mark module includes a target data source determining module, configured to respectively determine a target data source of each operation object characteristic of different levels if the activity log of the user consists of a plurality of data sources of different types. The optional structure may further include a data source weight value determining nodule, configured to determine a data source weight value of each target data source in the plurality of data sources of different types in the activity log of the user. The optional structure may further include a fourth operation object characteristic mark sub-module, configured to mark each operation object characteristic of different levels according to each data source weight value and the importance score corresponding to each operation object characteristic, to obtain a user preference score corresponding to each operation object characteristic of different levels.

Optionally, the user characteristic extraction apparatus may be a hardware device. The modules and units described above may be set as functional modules in the user characteristic extraction apparatus. FIG. 6 is a hardware structural block diagram of a user characteristic extraction apparatus. Referring to FIG. 6, the user characteristic extraction apparatus may include: a processor 1, a communications interface 2, a memory 3, and a communications bus 4. The processor 1, the communications interface 2, and the memory 3 communicate with each other by using the communications bus 4. Optionally, the communications interface 2 may be an interface of a communication module, for example, an interface of a GSM module.

The processor 1 is configured to execute a program, the memory 3 is configured to store the program, and the program may include program code, where the program code includes computer operation instructions.

The processor 1 may be a central processing unit (CPU), or an application specific integrated circuit (ASIC), or one or more integrated circuits configured to implement the embodiments of this application. The memory 3 may include a high-speed random access memory (RAM), or further include a non-volatile memory, for example, at least one magnetic disk storage.

The program may be configured for obtaining an activity log of a user, the activity log recording an operation behavior generated during a network operation process of the user. The program may further be configured for hierarchically extracting an operation object characteristic corresponding to the operation behavior from the operation behavior, to obtain operation object characteristics of different levels, the operation object characteristics of different levels having finer data granularities in descending order of levels. The program may be further configured for generating, for operation object characteristics of a same level, a user characteristic according to the operation behavior corresponding to the operation object characteristics.

The embodiments of this application disclose a user characteristic extraction method and related apparatus. The method includes: obtaining an activity log of a user, the activity log recording an operation behavior generated during a network operation process of the user; hierarchically extracting an operation object characteristic corresponding to the operation behavior from the operation behavior, to obtain operation object characteristics of different levels, the operation object characteristics of different levels having finer data granularities in descending order of levels; and generating, for operation object characteristics of a same level, a user characteristic according to the operation behavior corresponding to the operation object characteristics. It can be learned that according to the embodiments of this application, because the operation object characteristics are divided into different levels, a data granularity of the operation object characteristic is finer as a level number decreases in the operation object characteristics of different levels. According to the embodiments of this application, a user characteristic of a fine granularity can be mined from a level of the operation object characteristic that is of a fine granularity, thereby meeting requirements of some use scenarios that need to use a user characteristic of a fine granularity.

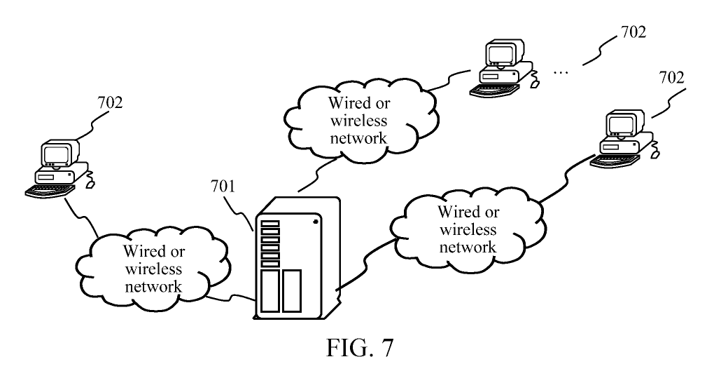

FIG. 7 is a schematic structural diagram of an advertisement push system according to an embodiment of this application. As shown in FIG. 7, FIG. 7 is a schematic structural diagram of an implementation environment related in this embodiment of this application. The advertisement push system includes a server 701 and at least one terminal 702.

The terminal 702 is connected to the server 701 by using a wireless or wired network. The terminal 702 may be a computer, a smartphone, a tablet, or other electronic devices, and includes a processor and a display apparatus.

The server 701 may be an Internet application server, and the Internet application server may provide a background service for an Internet application. The Internet application is an application program that provides a service of exchanging information such as audio, a video, an image, text for an intelligent terminal, and has advantages such as sending the audio, video, image, and text over communication operators and over operation system platforms.

The Internet application server may be configured as a server that provides the service by using the Internet. The Internet application server may be a social application server, for example, an instant messaging server, or a server corresponding to a forum or Weibo, and may alternatively be a server that can implement payment and other services by using the Internet. A type of the Internet application server is not specifically limited in this embodiment of this application.

Certainly, the server 701 may also be another server, for example, a multimedia resource share server. A type of the server is not specifically limited in this embodiment of this application.

In this embodiment of this application, an advertisement server determines a user characteristic according to the user characteristic extraction method in the foregoing embodiments, and determines a target user satisfying the user characteristic according to the user characteristic. The target user is a target user account related to application software. The advertisement server sends an advertisement message to a terminal on which the target user account is logged into, and the terminal on which the target user account is logged into displays the advertisement message. It can be learned that in this embodiment of this application, because a user characteristic of a fine granularity can be mined from a level of the operation object characteristic that is of a fine granularity, and information is pushed according to these user characteristics, so that the information is pushed more precisely and accurately, and the efficiency of information push is improved.

It should be noted that the embodiments in this specification are all described in a progressive manner. Description of each of the embodiments focuses on differences from other embodiments, and reference may be made to each other for the same or similar parts among respective embodiments. The apparatus embodiments are substantially similar to the method embodiments and therefore are only briefly described, and reference may be made to the method embodiments for the associated part.

A person skilled in the art may further realize that units and algorithm steps of each example described with reference to the embodiments disclosed herein can be implemented with electronic hardware, computer software, or the combination thereof. To clearly describe the interchangeability between the hardware and the software, compositions and steps of each example have been generally described according to functions in the foregoing descriptions. Whether these functions are performed by hardware or software depends on a particular application or design constraint conditions. A person skilled in the art may use different methods to implement the described functions for each particular application, without going beyond the scope of this application.

Steps of the method or algorithm described with reference to the embodiments disclosed herein may be directly implemented using hardware, a software module executed by a processor, or the combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

The above description of the disclosed embodiments enables a person skilled in the art to implement or use this application. Various modifications to these embodiments are obvious to a person skilled in the art, and the general principles defined in this specification may be implemented in other embodiments without departing from the spirit and scope of this application. Therefore, this application is not limited to these embodiments illustrated in this specification, but needs to conform to the broadest scope consistent with the principles and novel features disclosed in this specification.

What is claimed is:

1. A user characteristic extraction method, performed by a processor, and comprising:
obtaining an activity log of a user, the activity log including a recording of an operation behavior generated during a network operation process of the user;
hierarchically extracting an operation object characteristic corresponding to the operation behavior from the recording of the operation behavior;
obtaining, from the operation object characteristic, operation object characteristics of different levels, the operation object characteristics of different levels having finer data granularities in descending order of levels; and
generating, for operation object characteristics of a same level, a user characteristic according to the operation behavior corresponding to the operation object characteristics.

2. The method according to claim 1, wherein hierarchically extracting the operation object characteristic corresponding to the operation behavior from the recording of the operation behavior comprises:
hierarchically extracting the operation object characteristic corresponding to the operation behavior from the recording of the operation behavior according to a preset hierarchical class direction and hierarchical granularity level, to obtain the operation object characteristics of different levels.

3. The method according to claim 1, wherein after hierarchically extracting the operation object characteristic corresponding to the operation behavior from the recording of the operation behavior, the method further comprises:
obtaining a score corresponding to each operation object characteristic of different levels by marking each operation object characteristic of different levels.

4. The method according to claim 3, wherein obtaining the score corresponding to each operation object characteristic of different levels comprises:
determining a quantity of occurrences of each operation object characteristic of different levels in the activity log of the user;
determining an importance indicator of each operation object characteristic of different levels in the activity log of the user; and
marking each operation object characteristic of different levels according to the quantity of occurrences of each operation object characteristic of different levels in the activity log of the user and the importance indicator in the activity log of the user, to obtain an importance score corresponding to each operation object characteristic of different levels.

5. The method according to claim 3, wherein obtaining the score corresponding to each operation object characteristic of different levels comprises:
determining a weight value of the operation behavior corresponding to each operation object characteristic; and
marking each operation object characteristic of different levels according to the weight value of the operation behavior corresponding to each operation object characteristic and an importance score corresponding to each operation object characteristic, to obtain a user preference score corresponding to each operation object characteristic of different levels.

6. The method according to claim 3, wherein obtaining the score corresponding to each operation object characteristic of different levels comprises:
determining a time period in which the operation behavior corresponding to each operation object characteristic occurs;
determining a preset time attenuation weight value corresponding to each operation object characteristic; and
marking, in the time period in which the operation behavior corresponding to each operation object characteristic occurs, each operation object characteristic of different levels according to the preset time attenuation weight value corresponding to each operation object characteristic and an importance score corresponding to each operation object characteristic, to obtain a user preference score corresponding to each operation object characteristic of different levels.

7. The method according to claim 3, wherein obtaining the score corresponding to each operation object characteristic of different levels comprises:
respectively determining a target data source of each operation object characteristic of different levels if the activity log of the user consists of a plurality of data sources of different types;
determining a data source weight value of each target data source in the plurality of data sources of different types in the activity log of the user; and
marking each operation object characteristic of different levels according to each data source weight value and an importance score corresponding to each operation object characteristic, to obtain a user preference score corresponding to each operation object characteristic of different levels.

8. The method according to claim 1, further comprising:
determining, according to the user characteristic, a target user satisfying the user characteristic, the target user being a target user account related to application software;
establishing a connection to a terminal on which the target user account is logged into; and
sending an advertisement message to the terminal to enable the terminal to display the advertisement message.

9. A user characteristic extraction apparatus comprising a processor and a memory, wherein the memory is configured to store processor-executable instructions that, when executed by the processor, cause the processor to:
obtain an activity log of a user, the activity log including a recording of an operation behavior generated during a network operation process of the user;
hierarchically extract an operation object characteristic corresponding to the operation behavior from the operation behavior;
obtain, from the operation object characteristic, operation object characteristics of different levels, the operation object characteristics of different levels having finer data granularities in descending order of levels; and
generating, for operation object characteristics of a same level, a user characteristic according to the operation behavior corresponding to the operation object characteristics.

10. The apparatus according to claim 9, wherein the instructions, when executed by the processor, are further configured to cause the processor to:
hierarchically extract the operation object characteristic corresponding to the operation behavior from the operation behavior of the user on a network according to a preset hierarchical class direction and hierarchical granularity level, to obtain the operation object characteristics of different levels.

11. The apparatus according to claim 9, wherein the instructions, when executed by the processor, are further configured to cause the processor to:
obtain a score corresponding to each operation object characteristic of different levels by marking each operation object characteristic of different levels.

12. The apparatus according to claim 11, wherein the instructions, when executed by the processor, are configured to cause the processor to obtain the score corresponding to each operation object characteristic of different levels by:
determining a quantity of occurrences of each operation object characteristic of different levels in the activity log of the user;
determining an importance indicator of each operation object characteristic of different levels in the activity log of the user; and
marking each operation object characteristic of different levels according to the quantity of occurrences of each operation object characteristic of different levels in the activity log of the user and the importance indicator in the activity log of the user, to obtain an importance score corresponding to each operation object characteristic of different levels.

13. The apparatus according to claim 11, wherein the instructions, when executed by the processor, are configured to cause the processor to obtain the score corresponding to each operation object characteristic of different levels by:
determining a weight value of the operation behavior corresponding to each operation object characteristic; and
marking each operation object characteristic of different levels according to the weight value of the operation behavior corresponding to each operation object characteristic and an importance score corresponding to each operation object characteristic, to obtain a user preference score corresponding to each operation object characteristic of different levels.

14. The apparatus according to claim 11, wherein the instructions, when executed by the processor, are configured to cause the processor to obtain the score corresponding to each operation object characteristic of different levels by:
determining a time period in which the operation behavior corresponding to each operation object characteristic occurs;
determining a preset time attenuation weight value corresponding to each operation object characteristic; and
marking, in the time period in which the operation behavior corresponding to each operation object characteristic occurs, each operation object characteristic of different levels according to the preset time attenuation weight value corresponding to each operation object characteristic and an importance score corresponding to each operation object characteristic, to obtain a user preference score corresponding to each operation object characteristic of different levels.

15. The apparatus according to claim 11, wherein the instructions, when executed by the processor, are configured to cause the processor to obtain the score corresponding to each operation object characteristic of different levels by:
respectively determining a target data source of each operation object characteristic of different levels if the activity log of the user consists of a plurality of data sources of different types;
determining a data source weight value of each target data source in the plurality of data sources of different types in the activity log of the user; and
marking each operation object characteristic of different levels according to each data source weight value and an importance score corresponding to each operation object characteristic, to obtain a user preference score corresponding to each operation object characteristic of different levels.

16. A non-volatile storage medium configured to store one or more computer programs, the computer program comprising one or more processor executable instructions that, when executed by a processor, cause the processor to:
obtain an activity log of a user, the activity log including a recording of an operation behavior generated during a network operation process of the user;
hierarchically extract an operation object characteristic corresponding to the operation behavior from the operation behavior;
obtain, from the operation object characteristic, operation object characteristics of different levels, the operation object characteristics of different levels having finer data granularities in descending order of levels; and
generating, for operation object characteristics of a same level, a user characteristic according to the operation behavior corresponding to the operation object characteristics.

17. The non-volatile storage medium according to claim 16, further configured to store instructions that, when executed by the processor, cause the processor to:
hierarchically extract the operation object characteristic corresponding to the operation behavior from the operation behavior of the user on a network according to a preset hierarchical class direction and hierarchical granularity level, to obtain the operation object characteristics of different levels.

18. The non-volatile storage medium according to claim 16, further configured to store instructions that, when executed by the processor, cause the processor to:
obtain a score corresponding to each operation object characteristic of different levels by marking each operation object characteristic of different levels.

19. The non-volatile storage medium according to claim 18, wherein the instructions, when executed by the processor, cause the processor to obtain the score corresponding to each operation object characteristic of different levels by:
determining a quantity of occurrences of each operation object characteristic of different levels in the activity log of the user;
determining an importance indicator of each operation object characteristic of different levels in the activity log of the user; and
marking each operation object characteristic of different levels according to the quantity of occurrences of each operation object characteristic of different levels in the activity log of the user and the importance indicator in the activity log of the user, to obtain an importance score corresponding to each operation object characteristic of different levels.

20. The non-volatile storage medium according to claim 18, wherein the instructions, when executed by the processor, cause the processor to obtain the score corresponding to each operation object characteristic of different levels by:
determining a weight value of the operation behavior corresponding to each operation object characteristic; and
marking each operation object characteristic of different levels according to the weight value of the operation behavior corresponding to each operation object characteristic and an importance score corresponding to each operation object characteristic, to obtain a user preference score corresponding to each operation object characteristic of different levels.
